(19) United States
(12) Patent Application Publication
(10) Pub. No.: US 2015/0185665 A1
(43) Pub. Date: Jul. 2, 2015

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Satoshi Hatakeyama, Yokohama (JP)

(21) Appl. No.: 14/579,228

(22) Filed: Dec. 22, 2014

(30) Foreign Application Priority Data
Dec. 26, 2013 (JP) 2013-268955

(51) Int. Cl. G03G 15/16

(52) U.S. Cl. CPC G03G 15/16; G03G 15/657

(57) ABSTRACT

In accordance with one embodiment, an image forming apparatus comprises a photoconductive drum on which an electrostatic latent image is formed, a developing device configured to supply developing agent to the photoconductive drum, a transfer device configured to transfer the toner image formed on the photoconductive drum by the developing device to an image receiving medium, a rotatable loop-shaped transfer belt configured to convey the image receiving medium through a space between the transfer device and the photoconductive drum, and a peeling plate configured to be arranged on a conveyance path of the transfer belt and be applied with preset peeling electric charge to separate and discharge the image receiving medium from the photoconductive drum and the transfer belt after the transfer processing.

### CROSS-REFERENCE TO RELATED APPLICATION

This application is based upon and claims the benefit of priority from Japanese Patent Application No. 2013-268955, filed Dec. 26, 2013, the entire contents of which are incorporated herein by reference.

### FIELD

Embodiments described herein relate generally to an image forming apparatus such as an electrophotographic copier and the like in which a toner image on a photoconductive drum is transferred to an image receiving medium (paper) by a transfer device and then the image receiving medium adhered with the toner image is conveyed to a fixing device, and in which the paper subjected to the transfer processing can be peeled off from the photoconductive drum easily.

### BACKGROUND

Conventionally, in an image forming apparatus, the surface of a photoconductive drum (image carrier) is uniformly charged by a charger and the photoconductive drum surface is exposed to form an electrostatic latent image, and then the latent image is developed by a developing device to form a toner image. The toner image formed on the photoconductive drum surface is transferred to paper (image receiving medium) by a transfer device, and then the paper to which the toner image is transferred is separated from the photoconductive drum and conveyed to a fixing device to fix the toner image thereon, and then discharged.

Incidentally, though the paper to which the toner image is transferred is separated from the photoconductive drum, there is a case in which the paper is attracted to the photoconductive drum without being separated from the photoconductive drum, which may lead to problems such as paper jam and the like. To separate the paper from the photoconductive drum, for example, a peeling claw is used to forcibly separate the paper from the photoconductive drum.

However, there is a case in which the paper cannot be fully separated from the photoconductive drum only with the peeling claw, thus, conventionally, various paper peeling methods have been proposed.

For example, it is disclosed (see Japanese Unexamined Patent Application Publication No. Hei 8-62995) that after the toner image on the photoconductive drum is transferred to the paper, a guide is arranged to convey the paper separated from the transfer belt to the inlet of the fixing device, and the guide may be a material charged to the same polarity as the transfer surface of the paper.

It is disclosed (see Japanese Unexamined Patent Application Publication No. 10-39639) that a peeling module is arranged after the transfer member, a conductive member is arranged at the paper discharge side of the transfer member, and the conductive member is grounded to be charged to a polarity opposite to the polarity of the electric charge of the paper, thereby promoting the paper peeling operation through the attraction between opposite polarities.

However, there is a case in which the peeling performance of the paper is insufficient and the image noise caused by transfer failure occurs.

### BRIEF DESCRIPTION OF THE DRAWINGS

FIG. 1 is a diagram illustrating the constitution of an image forming apparatus according to one embodiment;

FIG. 2 is an enlarged diagram illustrating the constitution of an image forming section according to the embodiment;

FIG. 3 is an enlarged illustration diagram illustrating the main portions according to the embodiment; and

FIG. 4 is a plane view illustrating a photoconductive drum and a peeling plate according to the embodiment.

### DETAILED DESCRIPTION

In accordance with one embodiment, an image forming apparatus comprises a photoconductive drum on which an electrostatic latent image is formed, a developing device configured to supply developing agent to the photoconductive drum, a transfer device configured to transfer the toner image formed on the photoconductive drum by the developing device to an image receiving medium, a rotatable loop-shaped transfer belt configured to convey the image receiving medium through a space between the transfer device and the photoconductive drum, and a peeling plate configured to be arranged on a conveyance path of the transfer belt and be applied with preset peeling electric charge to separate and discharge the image receiving medium from the photoconductive drum and the transfer belt after the transfer processing.

Hereinafter, the embodiment of the present invention is described with reference to the accompanying drawings.

Further, the same components are indicated by the same reference numerals in the drawings and repetitive description is not provided.

### A First Embodiment

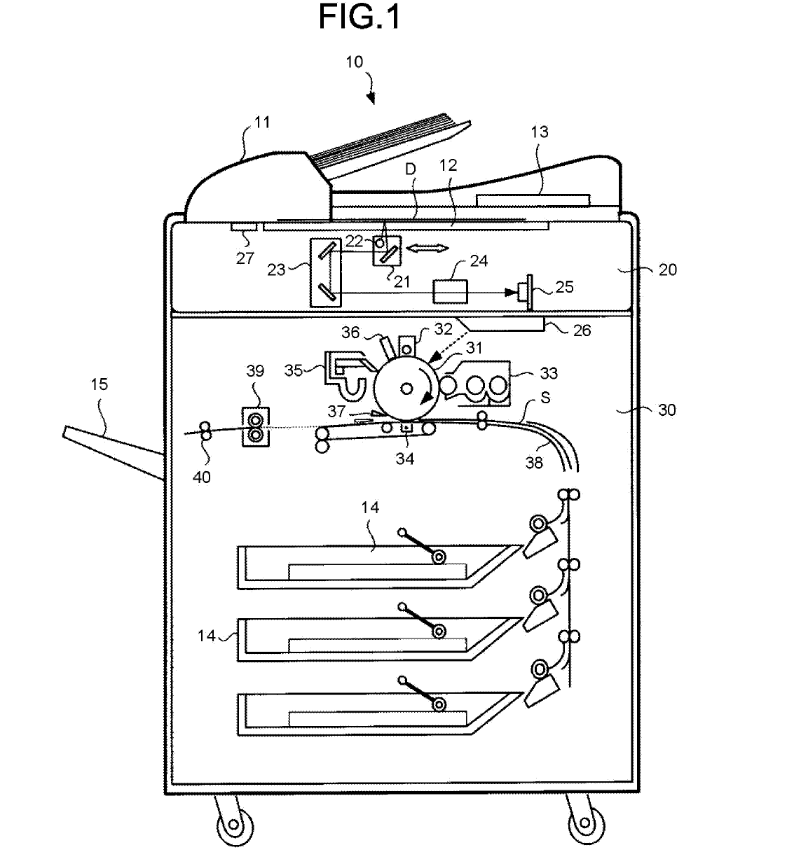

FIG. 1 is a diagram illustrating the constitution of the image forming apparatus according to the embodiment. In FIG. 1, an image forming apparatus 10 is, for example, a multi-function peripheral (MFP), a printer, a copier and the like. In the following description, the MFP is described as an example. An automatic document feeder (ADF) 11, a transparent document placing table 12 and an operation panel 13 are arranged at the upper portion of the image forming apparatus (MFP) 10. A plurality of paper feed devices 14 are arranged at the lower portion of the MFP 10, and a tray 15 for stacking paper is arranged at the lateral side of the MFP 10.

The MFP 10 includes a scanner section 20 and a printer section 30 below the ADF 11. The scanner section 20 reads an image on the document. The printer section 30 processes the image data read by the scanner section 20 and the print data input form a PC (Personal computer) and the like to form an image on an image receiving medium such as paper. In the following description, the paper S is described as one example of the image receiving medium.

The scanner section 20, which constitutes an image reading section, includes a carriage 21, an exposing lamp 22, a reflecting mirror 23, a condenser lens 24, a CCD (Charge Coupled Device) line sensor 25 and a laser unit 26. The scanner section 20 irradiates the document from below the document placing table 12 with the light from the exposing lamp 22 arranged in the carriage 21 to scan and read the document conveyed by the ADF 11 or the document placed on the document placing table 12. Then the reflected light from the document is reflected to the CCD line sensor 25 through the reflecting mirror 23 and the condenser lens 24.

The CCD line sensor 25 includes three line sensors equipped with blue, green and red color filters on the light receiving surface, and shift registers arranged corresponding to each line sensor. The light entering each line sensor is photoelectrically converted and image information is output. The image information is output as an analogue signal, and the analogue signal is converted into a digital signal and is then subjected to image processing to generate image data. The image data is send to the laser unit 26, and the laser unit 26 generates a laser beam according to the image data.

The printer section 30, which constitutes an image output section, includes a rotatable photoconductive drum 31. The photoconductive drum 31 serves as an image carrier, and a charging device 32, a developing device 33, a transfer device 34, a cleaning device 35, a charge removing lamp 36 and a peeling claw 37 are arranged around the photoconductive drum 31 in the rotation direction of the photoconductive drum 31. The laser beam from the laser unit 26 is emitted to the photoconductive drum 31 to form an electrostatic latent image corresponding to the image information of the document on the outer peripheral surface of the photoconductive drum 31.

When the image forming processing is started, the charging device 32 discharges at a predetermined discharge position to charges the outer peripheral surface of the rotating photoconductive drum 31 uniformly in the axis direction. Next, the photoconductive drum 31 is irradiated with the laser beam from the laser unit 26, and in this way, the electrostatic latent image is formed and maintained on the outer peripheral surface of the photoconductive drum 31.

The developing agent (for example, toner) is supplied from the developing device 33 to the outer peripheral surface of the photoconductive drum 31, and the electrostatic latent image is converted and developed into a toner image. Then the paper S is conveyed from the paper feed device 14 through the conveyance path 38 at a constant speed, and the toner image formed on the outer peripheral surface of the photoconductive drum 31 is electrostatically transferred to the paper S by the transfer device 34. The foreign substance such as the paper dregs and the like left on the photoconductive drum 31 is removed by the cleaning device 35 arranged in the post-stage of the transfer device 34 in the rotation direction of the photoconductive drum 31. The charge removing lamp 36 removes the charge left on the outer peripheral surface of the photoconductive drum 31.

In addition, the image forming section shown in FIG. 1 is simplified, and in a case of forming a color image, for example, the apparatus may be provided with black, magenta, cyan and yellow color image forming sections.

The paper S to which the toner image is transferred by the printer section 30 is conveyed to a fixing device 39. The fixing device 39, equipped with a fixing roller and a pressing roller opposite to each other, conveys the paper S through a space between the fixing roller and pressing roller to fix the toner image transferred to the paper S on the paper S. The paper S on which the toner image is fixed and on which the image formation is completed is discharged to the tray 15 by a paper discharge roller 40.

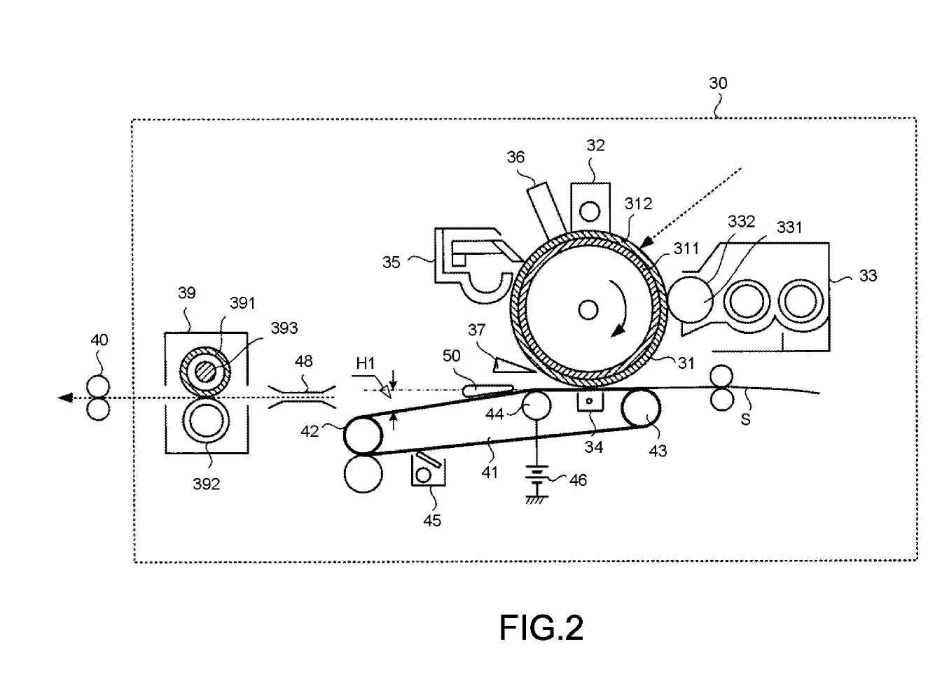

FIG. 2 is an enlarged diagram illustrating the constitution of an image forming section 30. In FIG. 2, the photoconductive drum 31 includes, for example, a hollow aluminum substrate 311 and a photoconductive layer 312 formed on the surface of the substrate 311. The photoconductive layer 312 includes, for example, an organic photo conductor (OPC). The substrate 311 is electrically grounded with the housing section of the image forming apparatus 10.

The developing device 33 includes a magnet roller 331 and a developing sleeve 332 rotating around the outer periphery of the magnet roller 331. The magnet roller 331 magnetically adsorbs the toner moving on the surface of the developing sleeve 332 and meanwhile supplies the toner selectively to the latent image on the surface of the photoconductive drum 31.

A rotatable loop-shaped transfer belt 41 for conveying the paper S between the transfer device 34 and the photoconductive drum 31, a driving roller 42 for driving the transfer belt 41 and a driven roller 43 are arranged around the transfer device 34. The transfer belt 41 is rotated by the driving roller 42 and the driven roller 43 to convey the paper S. Further, the toner image is transferred to the paper S conveyed on the transfer belt 41 through the electric field supplied by the transfer device 34. The peeling claw 37 separates the paper S subjected to the transfer processing from the surface of the photoconductive drum 31.

In the loop of the transfer belt 41, a power feed roller 44 is arranged, and a transfer belt cleaner 45 is arranged at the downstream side of the driving roller 42 in the rotation direction of the transfer belt 41. The power feed roller 44 is arranged between the driving roller 42 and the driven roller 43 and is connected with a DC power supply 46. The transfer belt 41 is charged to, for example, plus potential by the power feed roller 44. The transfer belt cleaner 45 cleans the transfer belt 41.

In a case in which the conveyance direction of the paper S is a direction A, the transfer belt 41 is slightly inclined from the power feed roller 44 towards the downstream side of the conveyance direction A. That is, the top of the power feed roller 44 is at a position (altitude difference is indicated by H1) higher than the top of the driving roller 42, and the transfer belt 41 is inclined from the power feed roller 44 towards the driving roller 42. A later-described peeling plate 50 is arranged above the inclined surface of the transfer belt 41.

The fixing device 39 includes a fixing roller 391 and a pressing roller 392. The fixing roller 391, which includes a heater 393 for generating heat at the inside thereof, is rotated in a state of being contacted with the pressing roller 392. Then the paper S fed through a guide 48 is passed through the space between the fixing roller 391 and the pressing roller 392 to fix the toner on the paper S.

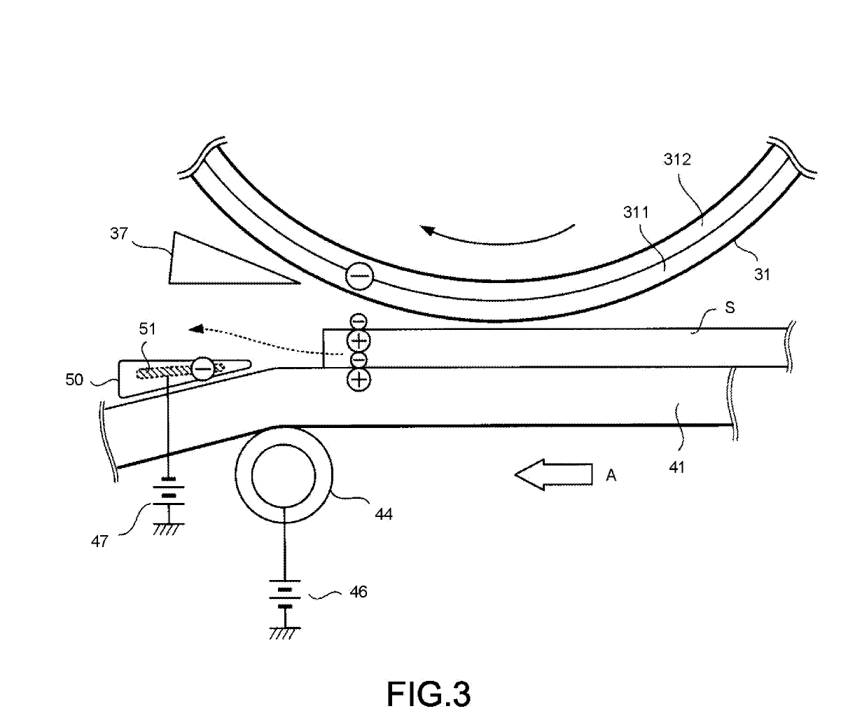

FIG. 3 is an enlarged illustration diagram illustrating a nip point (a toner transfer point where the toner image is transferred from the photoconductive drum 31 to the paper S) between the transfer belt 41 and the photoconductive drum 31.

As shown in FIG. 3, the transfer belt 41 is inclined from the power feed roller 44 towards the driving roller 42 with the power feed roller 44 taken as a starting point. The peeling plate 50 is arranged above the inclined surface of the transfer belt 41. That is, the peeling plate 50 is arranged at the downstream side of the paper conveyance direction A at a position deviated slightly from the toner transfer point, so as not to interfere with the conveyance of the paper S. A conductive power feed plate 51 is arranged inside the peeling plate 50.

The peeling plate 50, arranged in a state of non-contact with the transfer belt 41, is formed by, for example, resin having certain dielectric breakdown strength, and the power feed plate 51 is covered by the resin.

The power feed plate 51 is connected with a DC power supply 47, and peeling electric charge is applied to the power feed plate 51, thus, the power feed plate 51 is charged to, for example, minus (−) potential. In addition, the power feed plate may use conductive fiber or conductive rubber.

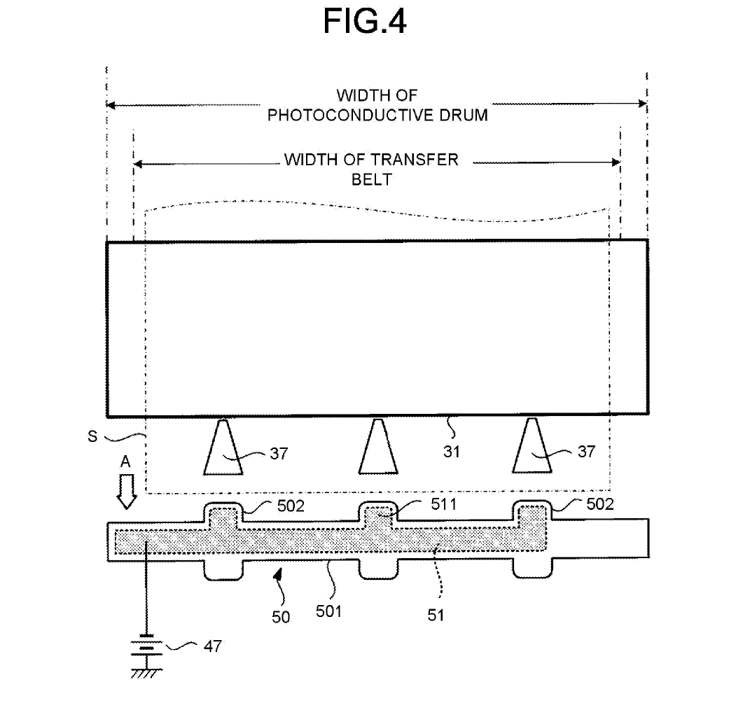

FIG. 4 is a plane view illustrating the photoconductive drum 31 and the peeling plate 50. The transfer belt 41 is not shown in FIG. 4, however, it is shown that the width of the transfer belt 41 is a little narrower than the width of the photoconductive drum 31. In a case in which the conveyance direction of the paper S is the direction A, a plurality of peeling claws 37 is arranged in a line orthogonal to the conveyance direction A in a manner of facing the photoconductive drum 31. The peeling claw 37 is contacted with the photoconductive drum 31, thus, the photoconductive layer may be worn out if the peeling claw 37 is contacted with the photoconductive drum 31 always at the same position. Thus, a moving mechanism is arranged to move the peeling claws 37 in the longitudinal direction of the photoconductive drum 31, which can prevent the photoconductive layer from being worn out, and can prolong the service life of the photoconductive drum 31.

Further, the peeling plate 50 includes a main body 501 extending in a direction parallel to the axis direction of the photoconductive drum 31, and a plurality of protruding portions 502 which are arranged on the main body 501 at predetermined intervals and protrude in the conveyance direction A of the paper S or protrude towards the photoconductive drum 31 at least. The protruding portions 502 are arranged at positions facing the peeling claws 37, however, it is not necessarily to face the protruding portions 502 to the peeling claws 37. The protruding portions 502 may be arranged at positions deviated from the positions of the peeling claws 37. The power feed plate 51 is arranged inside the peeling plate 50 and is connected with the DC power supply 47. The portions 511 of the power feed plate 51 corresponding to the protruding portions 502 protrude towards the photoconductive drum 31. Further, the power feed plate 51 may use the conductive fiber or conductive rubber.

When the paper S is conveyed in a direction indicated by an arrow A and passed through the nip point (toner transfer point) between the photoconductive drum 31 and the transfer belt 41, the toner image is transferred to the paper S conveyed on the transfer belt 41 by the transfer device 34 (refer to FIG. 2). At this time, the transfer belt 41 is charged to plus (+) potential by the power feed roller 44. Further, though most part of the paper S is charged to plus (+) potential, the surface facing the transfer belt 41 and the surface facing the photoconductive drum 31 are minus (−) in polarity.

The peeling electric charge is applied to the power feed plate 51 by the DC power supply 47, and the power feed plate 51 is charged to, for example, minus (−) potential; in this way, the surface of the paper S in minus polarity and the surface of the power feed plate 51 in minus polarity are mutually exclusive, as a result, the paper S is separated from the transfer belt 41. Further, the surface of the paper S facing the photoconductive drum 31 is charged to minus potential, and the surface of the photoconductive drum 31 where the toner is adhered is also charged to minus (−) potential originally, thus, the paper S is separated from the photoconductive drum 31. After being separated from the photoconductive drum 31 by the peeling claw 37, the paper S passes above the peeling plate 50 and is discharged to a next stage (fixing device 39). Thus, the paper S is discharged without being wound around the photoconductive drum 31.

Further, the power feed plate 51 may be charged to plus (+) potential by the DC power supply 47. In this case, the surface of the paper S in minus polarity and the surface of the power feed plate 51 in plus polarity are attracted to each other, as a result, the paper S is separated from the photoconductive drum 31, then the paper S passes above the peeling plate 50 and is discharged to a next stage (fixing device 39). Thus, the paper S is discharged without being wound around the photoconductive drum 31. As stated above, the paper S can be peeled off from the photoconductive drum 31 easily no matter the power feed plate 51 is charged to minus (−) potential or plus (+) potential.

Further, the transfer belt 41 is inclined in a direction away from the photoconductive drum 31 along the conveyance direction A at the position of the power feed plate 44, thus, the paper S on the transfer belt 41 is conveyed along the inclined surface, as a result, the paper S can be separated from the photoconductive drum 31 easily.

### A Second Embodiment

It is exemplified in the first embodiment that the peeling plate 50 covers the power feed plate 51 with resin, however, the peeling plate 50 may be formed by a stainless material. In this case, the power feed plate 51 is not needed, and the DC power supply 47 is directly connected to the stainless peeling plate 50 to apply the peeling electric charge.

In accordance with the embodiments described above, it is possible to prevent the paper from being attracted to the photoconductive drum and therefore prevent the occurrence of paper jam, and prevent the occurrence of transfer failure and the like. Thus, an image with higher quality can be formed.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus comprising:
a photoconductive drum on which an electrostatic latent image is formed;
a developing device configured to supply developing agent to the photoconductive drum;
a transfer device configured to transfer the toner image formed on the photoconductive drum by the developing device to an image receiving medium;
a rotatable loop-shaped transfer belt configured to convey the image receiving medium through a space between the transfer device and the photoconductive drum; and
a peeling plate configured to be arranged on a conveyance path of the transfer belt and be applied with preset peeling electric charge to separate and discharge the image receiving medium from the photoconductive drum and the transfer belt after the transfer processing.

2. The image forming apparatus according to claim 1, wherein
the peeling plate is arrange on the conveyance path at the downstream side of a toner transfer point, where the toner image on the photoconductive drum is transferred to the image receiving medium, in the conveyance direction of the image receiving medium.

3. The image forming apparatus according to claim 2, further comprising:
a driving roller configured to drive the transfer belt to rotate to convey the image receiving medium;
a driven roller; and
a power feed roller configured to be arranged between the driving roller and the driven roller at the downstream side of the toner transfer point to charge the transfer belt; wherein
the part of the transfer belt at the downstream side of the power feed roller is inclined in a direction away from the photoconductive drum, and the peeling plate is arranged on the inclined surface.

4. The image forming apparatus according to claim 1, wherein
the peeling plate is a conductive member extending in a direction parallel to the axis direction of the photoconductive drum, and includes a DC power supply configured to apply the preset peeling electric charge to the conductive member.

5. The image forming apparatus according to claim 1, wherein
the peeling plate includes a power feed plate which extends in a direction parallel to the axis direction of the photoconductive drum and is connected with the DC power supply, and resin that covers the power feed plate.

6. The image forming apparatus according to claim 4, wherein
the peeling plate includes a main body extending in a direction parallel to the axis direction of the photoconductive drum, and a plurality of protruding portions which are arranged on the main body at predetermined intervals and protrude in the conveyance direction of the image receiving medium.

7. The image forming apparatus according to claim 5, wherein
the peeling plate includes a main body extending in a direction parallel to the axis direction of the photoconductive drum, and a plurality of protruding portions which are arranged on the main body at predetermined intervals and protrude in the conveyance direction of the image receiving medium.
